(19) United States
(12) Patent Application Publication
(10) Pub. No.: US 2015/0222588 A1
(43) Pub. Date: Aug. 6, 2015

(54) APPARATUS AND METHOD FOR SHARING EXPERIENCE OF COMMUNICATION TERMINAL USER

(71) Applicant: Electronics and Telecommunications Research Institute, Daejeon (KR)

(72) Inventors: Rock-Won KIM, Daejeon (KR); Yun-Kyung PARK, Daejeon (KR); Jong-Hyun PARK, Daejeon (KR)

(21) Appl. No.: 14/614,373

(22) Filed: Feb. 4, 2015

(30) Foreign Application Priority Data
Feb. 6, 2014 (KR) 10-2014-0013841

(51) Int. Cl. H04L 12/58; H04L 29/08

(52) U.S. Cl. CPC H04L 51/32; H04L 67/1095

(57) ABSTRACT

Disclosed herein is an apparatus and method for sharing the experience of a communication terminal user. The apparatus includes a spatial-temporal information storage unit for storing spatial-temporal information based on an experience of a user who uses a communication terminal, an experience trajectory generation unit for generating experience trajectories, each composed of move and stop actions of the user, based on the stored spatial-temporal information, a semantic trajectory generation unit for grouping the generated experience trajectories and generating semantic trajectories for respective groups, a content editing unit for creating content associated with the generated semantic trajectories and editing the content, and a first communication unit for communicating with a server to share the semantic trajectories and the content associated with the semantic trajectories with other users.

### CROSS REFERENCE TO RELATED APPLICATION

This application claims the benefit of Korean Patent Application No. 10-2014-0013841 filed Feb. 6, 2014, which is hereby incorporated by reference in its entirety into this application.

### BACKGROUND OF THE INVENTION

1. Technical Field

The present invention generally relates to an apparatus and method for sharing the experience of a communication terminal user and, more particularly, to an apparatus and method for sharing the experience of a communication terminal user, which create content associated with semantic trajectories in which semantic information is assigned to the spatial-temporal information of a user, and share the content with other users.

2. Description of the Related Art

In the past, upon creating information related to travel as content and providing the content, travel-related information was updated, or required travel-related information was shared using personal blogs or homepages provided on the web.

However, since a system for sharing such travel information provides travel information in the form of individual files, it does not have unified schemes. Further, a plurality of files are aggregated in the system, thus resulting in many inconveniences in use. Methods capable of describing individual files are limited, so that it is inconvenient to provide even basic information related to pictures that are taken, and related to when and where the pictures are taken.

In addition, there is a problem in that users must read all lengthy posts to acquire actual information such as the locations of travel destinations or famous restaurants related to travel destinations and in that, even if users have read the posts, such a method is very inconvenient and the acquisition of exact information is difficult.

Recently, navigation devices have been widely used. Such a navigation device has a function similar to that of a black box, and thus it is possible to provide information about a movement trajectory along which a traveler moves during traveling. Such movement trajectory information may be output to the outside of the navigation device via a memory card. However, only services allowing a user to check his or her movement trajectory via a website provided by the company supplying the corresponding navigation device is currently provided.

In relation to this, Korean Patent Application Publication No. 2010-0040228 discloses technology entitled “Real-time Travel Assistance Service Based on GPS-integrated Portable Multimedia Device”.

### SUMMARY OF THE INVENTION

Accordingly, the present invention has been made keeping in mind the above problems occurring in the prior art, and an object of the present invention is to provide an apparatus and method for sharing the experience of a communication terminal user, which associate semantic trajectories, in which semantic information is assigned to the past spatial-temporal information of a user, with content such as images, audio, videos, and text related to the semantic trajectories, and which share resulting associated content with other users.

In accordance with an embodiment of the present invention to accomplish the above object, there is provided an apparatus for sharing an experience of a communication terminal user, including a spatial-temporal information storage unit for storing spatial-temporal information based on an experience of a user who uses a communication terminal; an experience trajectory generation unit for generating experience trajectories, each composed of move and stop actions of the user, based on the stored spatial-temporal information; a semantic trajectory generation unit for grouping the generated experience trajectories and generating semantic trajectories for respective groups; a content editing unit for creating content associated with the generated semantic trajectories and editing the content; and a first communication unit for communicating with a server to share the semantic trajectories and the content associated with the semantic trajectories with other users.

The spatial-temporal information may include any one of coordinate information and time information that are collected by a location collection unit provided in the communication terminal.

The experience trajectory generation unit may analyze a pattern of the spatial-temporal information, divides move and stop actions of the user, and generate the experience trajectories, each composed of repetitive move and stop actions of the user.

The move action of the user may include any one of coordinate information and time information that are collected by a location collection unit, and the stop action of the user may include any one of coordinate information, time information, place information, and stay time information that are collected by the location collection unit.

The semantic trajectory generation unit may include an indication unit for indicating the experience trajectories in a time sequence; a grouping unit for grouping the experience trajectories based on coordinate information or time information; a generation unit for generating the semantic trajectories in which meanings of trajectories for behavior types are assigned to respective experience trajectory groups; and an editing unit for editing experience trajectories included in each semantic trajectory.

The generation unit may hierarchically configure the semantic trajectories in a structure having an upper semantic trajectory and a plurality of lower semantic trajectories belonging to the upper semantic trajectory.

The content editing unit may create the content configured using at least one of a picture, text, audio, and a video and associate the content with each semantic trajectory, or edit externally acquired content and associate the edited content with each semantic trajectory, and also determine whether to open the content.

The first communication unit may transmit all or part of the semantic trajectories and the content associated with the semantic trajectories to the server.

The apparatus may further include a browser unit for requesting the server to search for a semantic trajectory of another user and content associated with the semantic trajectory and display results of the search, wherein the semantic trajectory and content of the other user are stored in the server.

The browser unit may receive from the user a search condition including any one of a path condition, a time condition, a content condition, a place condition, and a behavior condition, and request the server to search for the semantic trajectory of another user and content associated with the semantic trajectory through the first communication unit.

The server may include an account management unit for managing an account of the user who accesses the server through the first communication unit; a semantic trajectory storage unit for storing the semantic trajectories transmitted through the first communication unit; a content storage unit for storing the content associated with the semantic trajectories transmitted through the first communication unit; a semantic trajectory search unit for, when a request to search for a semantic trajectory of another user is received from the user through the first communication unit, searching the semantic trajectory storage unit for the semantic trajectory according to a search condition input by the user; a content search unit for, when a request to search for content associated with the semantic trajectory of another user is received from the user through the first communication unit, searching the content storage unit for the content according to a search condition input by the user; and a second communication unit for transmitting results of the search performed by the semantic trajectory search unit and the content search unit to the first communication unit.

In accordance with another embodiment of the present invention to accomplish the above object, there is provided a method for sharing an experience of a communication terminal user, including storing, by a spatial-temporal information storage unit, spatial-temporal information of a user who uses a communication terminal; generating, by an experience trajectory generation unit, experience trajectories, each composed of move and stop actions of the user, based on the stored spatial-temporal information; grouping, by a semantic trajectory generation unit, the generated experience trajectories and generating, by the semantic trajectory generation unit, semantic trajectories for respective groups; creating, by a content editing unit, content associated with the generated semantic trajectories and editing, by the content editing unit, the content; and communicating, by a first communication unit, with a server to share the semantic trajectories and the content associated with the semantic trajectories with other users.

Generating the experience trajectories, each composed of the move and stop actions of the user, based on the stored spatial-temporal information may include analyzing a pattern of the spatial-temporal information, dividing move and stop actions of the user, and generating the experience trajectories, each composed of repetitive move and stop actions of the user, and the move action of the user includes any one of coordinate information and time information that are collected by a location collection unit, and the stop action of the user includes any one of coordinate information, time information, place information, and stay time information that are collected by the location collection unit.

Grouping the generated experience trajectories and generating the semantic trajectories for respective groups may include indicating the experience trajectories in a time sequence; grouping the experience trajectories based on coordinate information or time information; generating the semantic trajectories in which meanings of trajectories for behavior types are assigned to respective experience trajectory groups; and editing experience trajectories included in each semantic trajectory.

Creating and editing the content associated with the semantic trajectories may include creating the content configured using at least one of a picture, text, audio, and a video and associating the content with each semantic trajectory, or editing externally acquired content and associating the edited content with each semantic trajectory, and also determining whether to open the content.

Communicating with the server to share the semantic trajectories and the content associated with the semantic trajectories with other users may include transmitting all or part of the semantic trajectories and the content associated with the semantic trajectories to the server.

The method may further include, after communicating with the server to share the semantic trajectories and the content associated with the semantic trajectories with other users, requesting the server to search for a semantic trajectory of another user and content associated with the semantic trajectory and displaying results of the search, wherein the semantic trajectory and content of the other user are stored in the server.

Requesting the server to search for the semantic trajectory of the other user and content associated with the semantic trajectory and displaying the results of the search may include receiving from the user a search condition including any one of a path condition, a time condition, a content condition, a place condition, and a behavior condition, and requesting the server to search for the semantic trajectory of the other user and content associated with the semantic trajectory through the first communication unit.

The method may further include, after requesting the server to search for the semantic trajectory of the other user and the content associated with the semantic trajectory and displaying the results of the search, the server performing managing an account of the user who accesses the server through the first communication unit; storing the semantic trajectories transmitted through the first communication unit; storing the content associated with the semantic trajectories transmitted through the first communication unit; when a request to search for a semantic trajectory of another user is received from the user through the first communication unit, searching the stored semantic trajectories for the semantic trajectory according to a search condition input by the user; when a request to search for content associated with the semantic trajectory of the other user is received from the user through the first communication unit, searching the stored content for the associated content according to a search condition input by the user; and transmitting results of the search to the first communication unit.

The apparatus and method for sharing the experience of a communication terminal user according to the present invention having the above configuration are advantageous in that they generate semantic trajectories in which semantic information is assigned to the user's spatial-temporal information, create content, such as an image, audio, a video, and text associated with the semantic trajectories, and share the content associated with the semantic trajectories with a plurality of other users, thus enabling the shared information to be utilized for searching for a place conforming to a purpose or planning a path of travel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for sharing the experience of a communication terminal user according to the present invention;

FIG. 2 is a diagram showing the generation of an experience trajectory by an experience trajectory generation unit employed in the apparatus for sharing the experience of a communication terminal user according to the present invention;

FIG. 3 is a diagram showing the detailed configuration of a semantic trajectory generation unit employed in the apparatus for sharing the experience of a communication terminal user according to the present invention;

FIG. 4 is a diagram showing the generation of semantic trajectories by the semantic trajectory generation unit of FIG. 3;

FIG. 5 is a diagram showing a search for semantic trajectories and content performed by a browser unit employed in the apparatus for sharing the experience of a communication terminal user according to the present invention;

FIG. 6 is a diagram showing the configuration of a server connected to the apparatus for sharing the experience of a communication terminal user according to the present invention; and

FIG. 7 is a flowchart showing the sequence of a method for sharing the experience of a communication terminal user according to the present invention.

FIG. 8 is an embodiment of the present invention implemented in a computer system.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations which are deemed to make the gist of the present invention obscure will be omitted.

Hereinafter, an apparatus and method for sharing the experience of a communication terminal user according to an embodiment of the present invention will be described in detail with reference to the attached drawings.

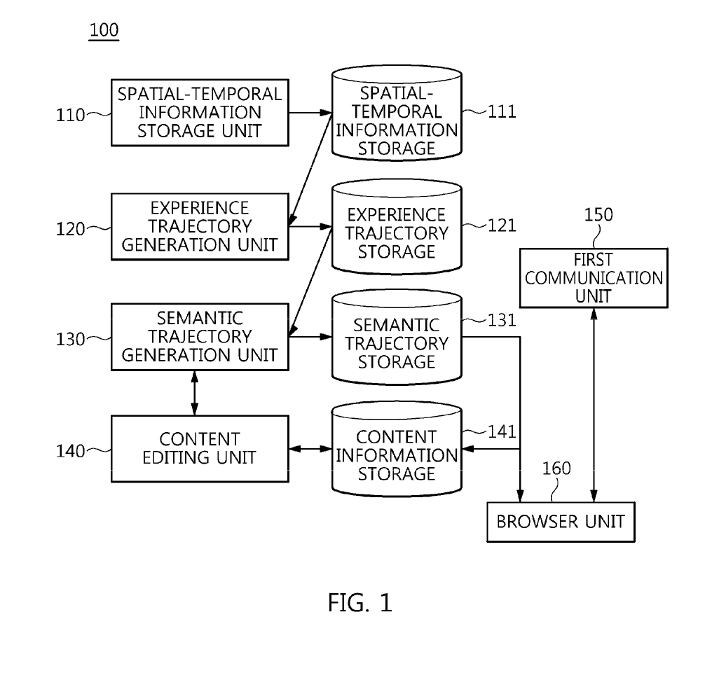

FIG. 1 is a diagram showing the configuration of an apparatus for sharing the experience of a communication terminal user according to the present invention.

Referring to FIG. 1, an apparatus 100 for sharing the experience of a communication terminal user according to the present invention chiefly includes a spatial-temporal information storage unit 110, an experience trajectory storage unit 120, a semantic trajectory storage unit 130, a content editing unit 140, a first communication unit 150, and a browser unit 160.

The spatial-temporal information storage unit 110 stores the spatial-temporal information of a user who uses a communication terminal Here, the spatial-temporal information includes any one of coordinate information and time information that are collected by a location collection means provided in the communication terminal That is, the spatial-temporal information storage unit 110 combines coordinate information and time information that are collected by a Global Positioning System (GPS) provided in the communication terminal, and stores history of the movement path of the user in a spatial-temporal information storage 111.

The experience trajectory generation unit 120 generates experience trajectories, each composed of the move and stop actions of the user, based on the stored spatial-temporal information, and stores the experience trajectories in an experience trajectory storage 121.

The semantic trajectory generation unit 130 groups the generated experience trajectories, generates semantic trajectories for respective groups, and stores the semantic trajectories in a semantic trajectory storage 131.

The content editing unit 140 creates and edits content associated with the generated semantic trajectories, and stores the created and edited content in a content information storage 141. The content editing unit 140 creates content composed of at least one of a picture, text, audio, and a video and associates the content with each semantic trajectory, or edits externally acquired content and associates the edited content with each semantic trajectory. Further, since the content editing unit 140 may determine whether to open the content, it may assign precise semantic information to help in searching for semantic trajectories, and may protect information sensitive to the user's privacy by eliminating or editing experience trajectories and content undesired by the user.

The first communication unit 150 communicates with a server to share the semantic trajectories and content associated therewith with other users. The first communication unit 150 transmits all or part of the semantic trajectories and content associated therewith to the server. In this case, the first communication unit 150 transmits the semantic trajectories and content associated therewith using a protocol interpretable by the server. Further, the first communication unit 150 receives the results of searching for semantic trajectories of another user and the results of searching for content associated with the semantic trajectories from the server, and provides the received search results to the user through the browser unit 160.

The browser unit 160 requests the server to search for the semantic trajectories of another user and content associated therewith, which are stored in the server, and displays the results of the search. That is, the browser unit 160 receives from the user a search condition including any one of a path condition, a time condition, a content condition, a place condition, and a behavior condition, requests the server to search for the semantic trajectories of the other user and content associated therewith through the first communication unit 150, and displays the results of the search.

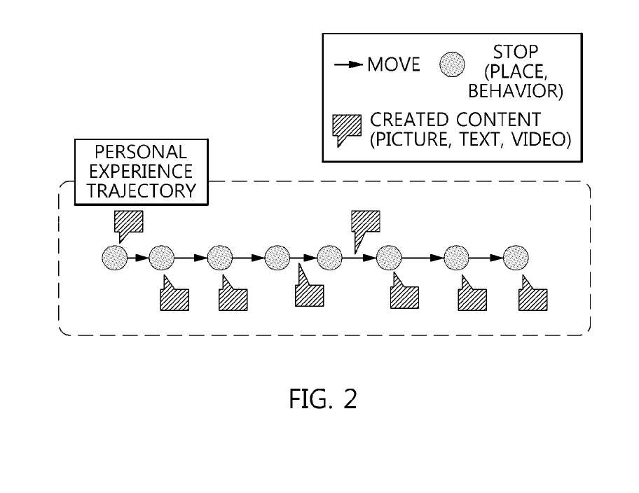

FIG. 2 is a diagram showing the generation of an experience trajectory by the experience trajectory generation unit employed in the apparatus for sharing the experience of a communication terminal user according to the present invention.

Referring to FIG. 2, the experience trajectory generation unit 120 according to the present invention generates an experience trajectory composed of move and stop actions of a user, based on stored spatial-temporal information.

More specifically, the experience trajectory generation unit 120 analyzes the pattern of the spatial-temporal information, divides the move and stop actions of the user, and generates an experience trajectory composed of repetitive move and stop actions of the user, as shown in the drawing. Here, the move action of the user includes any one of coordinate information and time information that are collected by the location collection means, and the stop action of the user includes any one of coordinate information, time information, place information, and stay time information that are collected by the location collection means.

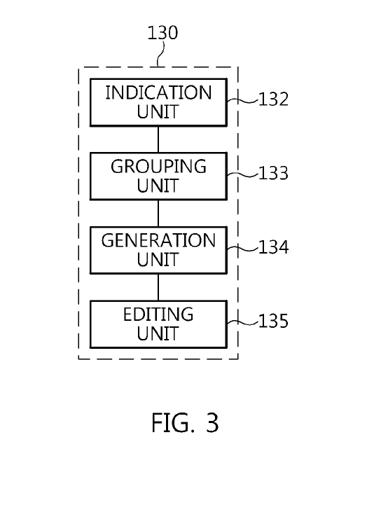

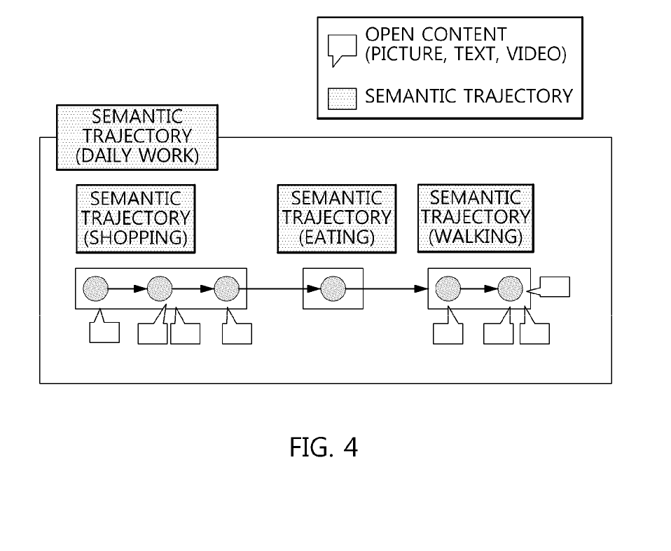

FIG. 3 is a diagram showing the detailed configuration of the semantic trajectory generation unit employed in the apparatus for sharing the experience of a communication terminal user according to the present invention. FIG. 4 is a diagram showing the generation of semantic trajectories by the semantic trajectory generation unit of FIG. 3.

Referring to FIG. 3, the semantic trajectory generation unit 130 according to the present invention groups generated experience trajectories and generates semantic trajectories for respective groups.

For this, the semantic trajectory generation unit 130 includes an indication unit 132, a grouping unit 133, a generation unit 134, and an editing unit 135.

The indication unit 132 indicates the experience trajectories on a map in a time sequence.

The grouping unit 133 groups the experience trajectories based on coordinate information or time information. That is, the grouping unit 133 may group the experience trajectories for respective places and locations based on the coordinate information, and may group the experience trajectories for respective times based on the time information.

The generation unit 134 generates semantic trajectories in which the meanings of trajectories for behavior types are assigned to respective experience trajectory groups. The generation unit 134 hierarchically configures the semantic trajectories in a structure having an upper semantic trajectory and a plurality of lower semantic trajectories belonging to the upper semantic trajectory. This configuration will be described in detail below with reference to FIG. 4. That is, the experience trajectories including the user's stop and move actions may be grouped into three types of lower semantic trajectories and one type of upper semantic trajectory. Here, actions such as shopping, eating, and walking are assigned, as the meanings of trajectories, to the three types of lower semantic trajectories, and an action such as daily work is assigned, as the meaning of a trajectory, to the one type of upper semantic trajectory.

The editing unit 135 edits experience trajectories included in each semantic trajectory. The editing unit 135 may delete an experience trajectory, or merge a plurality of experience trajectories into a single experience trajectory. Further, the editing unit 135 may input a place name when an exact place name is not included in an experience trajectory corresponding to a stop action.

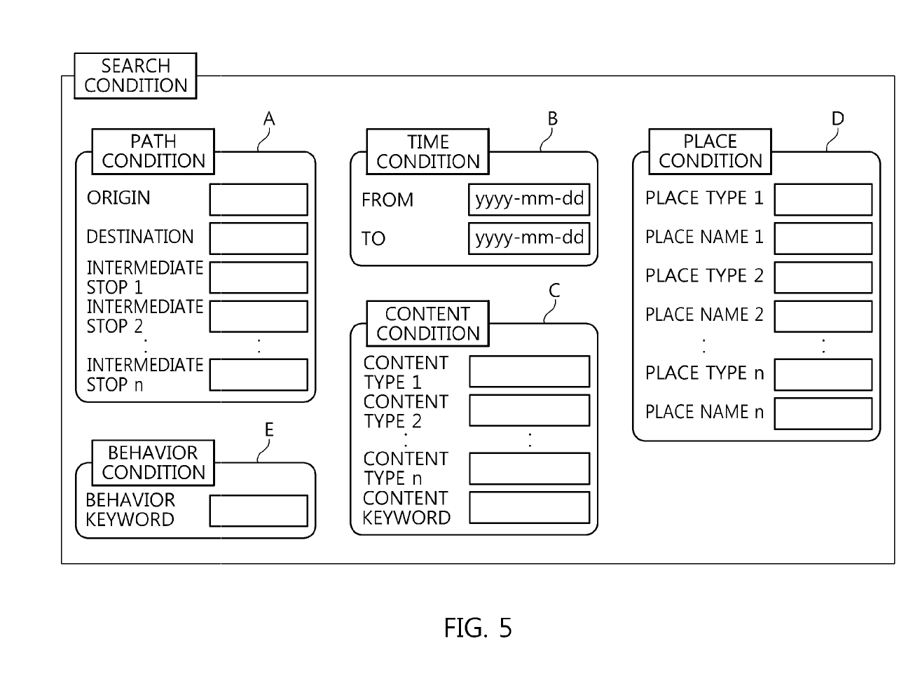

FIG. 5 is a diagram showing a search for semantic trajectories and content performed by the browser unit employed in the apparatus for sharing the experience of a communication terminal user according to the present invention.

Referring to FIG. 5, the browser unit 160 of the present invention requests the server to search for semantic trajectories of another user and content associated therewith, which are stored in the server, and displays the results of the search. That is, as shown in the drawing, the browser unit 160 receives from the user a search condition including any one of path condition A, time condition B, content condition C, place condition D, and behavior condition E, requests the server to search for semantic trajectories of the other user and content associated therewith, and displays the results of the search. That is, a relation between the path condition A, time condition B, content condition C, place condition D, and behavior condition E is “AND”, and detailed keywords thereof may be searched on the condition of “AND” and “OR”. More specifically, when a plurality of content types are designated in the content condition C, content types are searched on the condition of “OR”. Further, in the place condition D, a place type and a place name form a single pair, and only one of a place name and a place type may be designated. When a plurality of place type-name pairs are designated in the place condition D, those pairs are searched on the condition of “OR”. All of the search conditions are options, and conditions are not filtered unless the conditions are specified. Therefore, if the user does not specify any conditions, it means that all semantic trajectories will be searched.

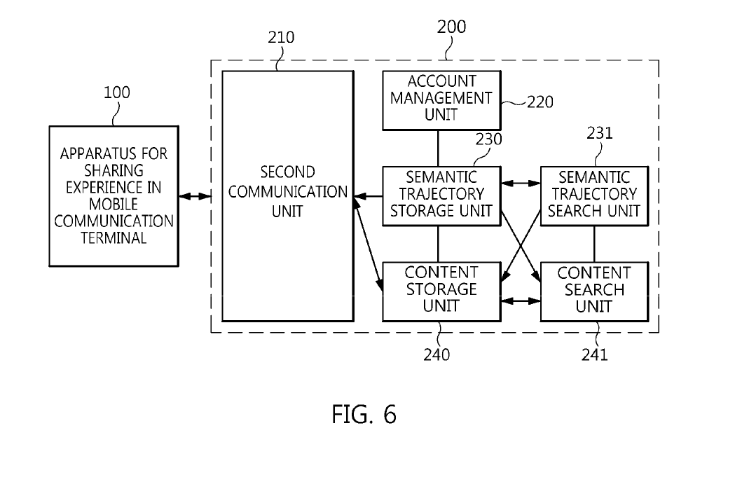

FIG. 6 is a diagram showing the configuration of the server connected to the apparatus for sharing the experience of a communication terminal user according to the present invention.

Referring to FIG. 6, a server 200 according to the present invention chiefly includes a second communication unit 210, an account management unit 220, a semantic trajectory storage unit 230, a semantic trajectory search unit 231, a content storage unit 240, and a content search unit 241.

The second communication unit 210 receives semantic trajectories and content associated therewith from the first communication unit 150, and transmits the results of a search performed by the semantic trajectory search unit 231 and the content search unit 241, which will be described later, to the first communication unit 150.

The account management unit 220 manages the account of the user who accesses the server. The account management unit 220 connects a session with the communication terminal of the user when an account, to which the user logs in, is correct.

The semantic trajectory storage unit 230 stores the semantic trajectories transmitted through the first communication unit 150.

When a request to search for semantic trajectories of another user is received from the user through the first communication unit 150, the semantic trajectory search unit 231 searches the semantic trajectory storage unit 230 for semantic trajectories according to the search condition input by the user.

The content storage unit 240 stores content associated with the semantic trajectories transmitted through the first communication unit 150.

When a request to search for content associated with the semantic trajectories of the other user is received from the user through the first communication unit 150, the content search unit 241 searches the content storage unit 240 for the content according to the search condition input by the user.

Based on the server 200 configured in this way, when the request to search for the semantic trajectories of the other user and content associated therewith is received from the user, that is, when the user inputs “Daejeon” as an origin, “Seocheon” as a destination, and “Sudeoksa Temple” as an intermediate stop 1 in the path condition through the browser unit 160, and requests the search, the semantic trajectory search unit 231 searches the semantic trajectory storage unit 230 that stores semantic trajectories for a semantic trajectory sequentially including “Daejeon”, “Sudeoksa Temple”, and “Seocheon”. Here, in the time condition, when “2011-07-01” and “current time” are additionally designated as “From” and “To”, respectively, the semantic trajectory search unit 231 searches for only a semantic trajectory satisfying the designated time. Further, in the search condition, when “picture” is selected as a content type, and “chopped noodles” is input as a content keyword, the semantic trajectory search unit 231 searches for a semantic trajectory having pictures, each having a title including a description of “chopped noodles”, as content.

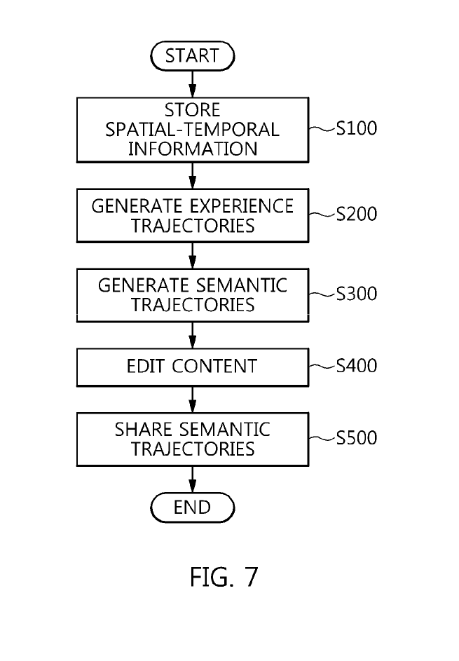

FIG. 7 is a flowchart showing the sequence of a method for sharing the experience of a communication terminal user according to the present invention.

Referring to FIG. 7, the method for sharing the experience of a communication terminal user according to the present invention uses the above-described apparatus 100 for sharing the experience of a communication terminal user, and thus a repeated description thereof will be omitted here.

First, the apparatus 100 stores the spatial-temporal information of a user who uses a communication terminal at step S100.

Next, the apparatus 100 generates experience trajectories, each composed of the move and stop actions of the user, based on the stored spatial-temporal information at step S200. Step S200 is configured to analyze the pattern of the spatial-temporal information, divide the move and stop actions of the user, and generate experience trajectories, each composed of repetitive move and stop actions of the user.

Then, the apparatus 100 groups the generated experience trajectories and generates semantic trajectories for respective groups at step S300. Step S300 is configured to indicate the experience trajectories in a time sequence, group the experience trajectories based on coordinate information or time information, and generate semantic trajectories in which the meanings of trajectories for behavior types are assigned to respective experience trajectory groups.

Then, the apparatus 100 creates and edits content associated with the generated semantic trajectories at step S400. Step S400 is configured to create content composed of at least one of a picture, text, audio, and a video and associate the content with each semantic trajectory, or to edit externally acquired content and associate the edited content with each semantic trajectory.

Thereafter, the apparatus 100 communicates with the server so as to share the semantic trajectories and content associated therewith with other users at step S500. Step S500 is configured to transmit all or part of the semantic trajectories and content associated therewith to the server.

After step S500, the apparatus 100 requests the server to search for the semantic trajectories of another user and content associated therewith, which are stored in the server, and displays the results of search. Thereafter, the server manages the account of the user who accesses the server through the first communication unit. Next, the server stores semantic trajectories transmitted through the first communication unit. Further, the server stores content associated with the semantic trajectories transmitted through the first communication unit. Then, when a request to search for the semantic trajectories of the other user is received from the user through the first communication unit, the server searches the semantic trajectory storage unit for semantic trajectories according to the search condition input by the user. Next, when a request to search for content associated with the semantic trajectories of another user is received from the user through the first communication unit, the server searches the content storage unit for content according to the search condition input by the user. The search results are transmitted to the first communication unit.

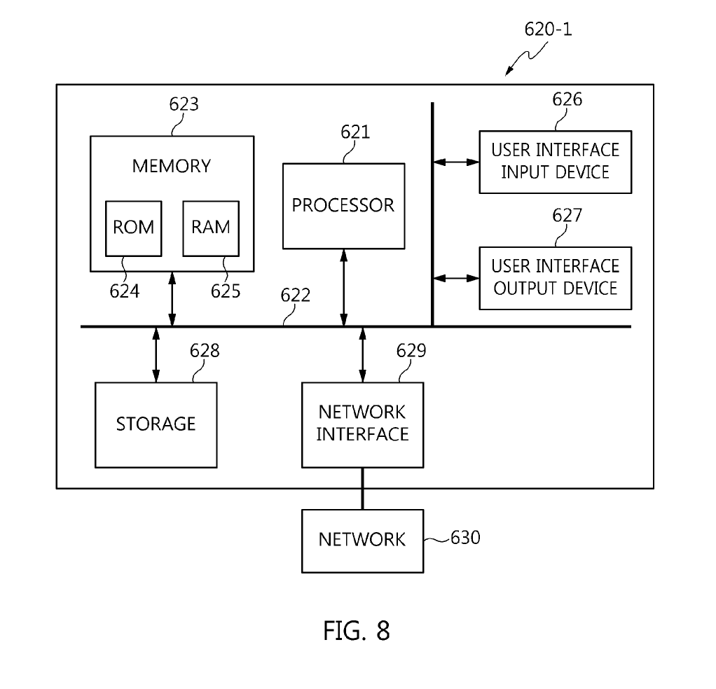

FIG. 8 is an embodiment of the present invention implemented in a computer system.

Referring to FIG. 8, an embodiment of the present invention may be implemented in a computer system, e.g., as a computer readable medium. As shown in in FIG. 8, a computer system 620-1 may include one or more of a processor 621, a memory 623, a user interface input device 626, a user interface output device 627, and a storage 628, each of which communicates through a bus 622. The computer system 620-1 may also include a network interface 629 that is coupled to a network 630. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory (RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As described above, the apparatus and method for sharing the experience of a communication terminal user according to the present invention generate semantic trajectories in which semantic information is assigned to the user's spatial-temporal information, create content, such as an image, audio, a video, and text associated with the semantic trajectories, and share the content associated with the semantic trajectories with a plurality of other users, thus enabling the shared information to be utilized for searching for a place conforming to a purpose or planning a path of travel.

Although the preferred embodiments of the present invention have been disclosed for illustrative purposes, it will be understood that the present invention may be modified in various forms, and those skilled in the art may practice various modifications and changes, without departing from the scope and spirit of the invention as disclosed in the accompanying claims.

What is claimed is:

1. An apparatus for sharing an experience of a communication terminal user, comprising:
a spatial-temporal information storage unit for storing spatial-temporal information based on an experience of a user who uses a communication terminal;
an experience trajectory generation unit for generating experience trajectories, each composed of move and stop actions of the user, based on the stored spatial-temporal information;
a semantic trajectory generation unit for grouping the generated experience trajectories and generating semantic trajectories for respective groups;
a content editing unit for creating content associated with the generated semantic trajectories and editing the content; and
a first communication unit for communicating with a server to share the semantic trajectories and the content associated with the semantic trajectories with other users.

2. The apparatus of claim 1, wherein the spatial-temporal information includes any one of coordinate information and time information that are collected by a location collection unit provided in the communication terminal

3. The apparatus of claim 1, wherein the experience trajectory generation unit analyzes a pattern of the spatial-temporal information, divides move and stop actions of the user, and generates the experience trajectories, each composed of repetitive move and stop actions of the user.

4. The apparatus of claim 3, wherein the move action of the user includes any one of coordinate information and time information that are collected by a location collection unit, and the stop action of the user includes any one of coordinate information, time information, place information, and stay time information that are collected by the location collection unit.

5. The apparatus of claim 1, wherein the semantic trajectory generation unit comprises:
an indication unit for indicating the experience trajectories in a time sequence;
a grouping unit for grouping the experience trajectories based on coordinate information or time information;
a generation unit for generating the semantic trajectories in which meanings of trajectories for behavior types are assigned to respective experience trajectory groups; and
an editing unit for editing experience trajectories included in each semantic trajectory.

6. The apparatus of claim 5, wherein the generation unit hierarchically configures the semantic trajectories in a structure having an upper semantic trajectory and a plurality of lower semantic trajectories belonging to the upper semantic trajectory.

7. The apparatus of claim 1, wherein the content editing unit creates the content configured using at least one of a picture, text, audio, and a video and associates the content with each semantic trajectory, or edits externally acquired content and associates the edited content with each semantic trajectory, and also determines whether to open the content.

8. The apparatus of claim 1, wherein the first communication unit transmits all or part of the semantic trajectories and the content associated with the semantic trajectories to the server.

9. The apparatus of claim 1, further comprising a browser unit for requesting the server to search for a semantic trajectory of another user and content associated with the semantic trajectory and display results of the search, wherein the semantic trajectory and content of the other user are stored in the server.

10. The apparatus of claim 9, wherein the browser unit receives from the user a search condition including any one of a path condition, a time condition, a content condition, a place condition, and a behavior condition, and requests the server to search for the semantic trajectory of another user and content associated with the semantic trajectory through the first communication unit.

11. The apparatus of claim 1, wherein the server comprises:
an account management unit for managing an account of the user who accesses the server through the first communication unit;
a semantic trajectory storage unit for storing the semantic trajectories transmitted through the first communication unit;
a content storage unit for storing the content associated with the semantic trajectories transmitted through the first communication unit;
a semantic trajectory search unit for, when a request to search for a semantic trajectory of another user is received from the user through the first communication unit, searching the semantic trajectory storage unit for the semantic trajectory according to a search condition input by the user;
a content search unit for, when a request to search for content associated with the semantic trajectory of another user is received from the user through the first communication unit, searching the content storage unit for the content according to a search condition input by the user; and
a second communication unit for transmitting results of the search performed by the semantic trajectory search unit and the content search unit to the first communication unit.

12. A method for sharing an experience of a communication terminal user, comprising:
storing, by a spatial-temporal information storage unit, spatial-temporal information of a user who uses a communication terminal;
generating, by an experience trajectory generation unit, experience trajectories, each composed of move and stop actions of the user, based on the stored spatial-temporal information;
grouping, by a semantic trajectory generation unit, the generated experience trajectories and generating, by the semantic trajectory generation unit, semantic trajectories for respective groups;
creating, by a content editing unit, content associated with the generated semantic trajectories and editing, by the content editing unit, the content; and
communicating, by a first communication unit, with a server to share the semantic trajectories and the content associated with the semantic trajectories with other users.

13. The method of claim 12, wherein:
generating the experience trajectories, each composed of the move and stop actions of the user, based on the stored spatial-temporal information comprises analyzing a pattern of the spatial-temporal information, dividing move and stop actions of the user, and generating the experience trajectories, each composed of repetitive move and stop actions of the user, and
the move action of the user includes any one of coordinate information and time information that are collected by a location collection unit, and the stop action of the user includes any one of coordinate information, time information, place information, and stay time information that are collected by the location collection unit.

14. The method of claim 12, wherein grouping the generated experience trajectories and generating the semantic trajectories for respective groups comprises:
indicating the experience trajectories in a time sequence;
grouping the experience trajectories based on coordinate information or time information;
generating the semantic trajectories in which meanings of trajectories for behavior types are assigned to respective experience trajectory groups; and
editing experience trajectories included in each semantic trajectory.

15. The method of claim 12, wherein creating and editing the content associated with the semantic trajectories comprises creating the content configured using at least one of a picture, text, audio, and a video and associating the content with each semantic trajectory, or editing externally acquired content and associating the edited content with each semantic trajectory, and also determining whether to open the content.

16. The method of claim 12, wherein communicating with the server to share the semantic trajectories and the content associated with the semantic trajectories with other users comprises transmitting all or part of the semantic trajectories and the content associated with the semantic trajectories to the server.

17. The method of claim 12, further comprising, after communicating with the server to share the semantic trajectories and the content associated with the semantic trajectories with other users, requesting the server to search for a semantic trajectory of another user and content associated with the semantic trajectory and displaying results of the search, wherein the semantic trajectory and content of the other user are stored in the server.

18. The method of claim 17, wherein requesting the server to search for the semantic trajectory of the other user and content associated with the semantic trajectory and displaying the results of the search comprises receiving from the user a search condition including any one of a path condition, a time condition, a content condition, a place condition, and a behavior condition, and requesting the server to search for the semantic trajectory of the other user and content associated with the semantic trajectory through the first communication unit.

19. The method of claim 17, further comprising, after requesting the server to search for the semantic trajectory of the other user and the content associated with the semantic trajectory and displaying the results of the search, the server performing:
managing an account of the user who accesses the server through the first communication unit;
storing the semantic trajectories transmitted through the first communication unit;
storing the content associated with the semantic trajectories transmitted through the first communication unit;
when a request to search for a semantic trajectory of another user is received from the user through the first communication unit, searching the stored semantic trajectories for the semantic trajectory according to a search condition input by the user;
when a request to search for content associated with the semantic trajectory of the other user is received from the user through the first communication unit, searching the stored content for the associated content according to a search condition input by the user; and
transmitting results of the search to the first communication unit.
